(19) United States
(12) Patent Application Publication
(10) Pub. No.: US 2010/0141668 A1
(43) Pub. Date: Jun. 10, 2010

(54) ADDRESS CALCULATION UNIT

(75) Inventors: Winfried Gehrke, Sittensen (DE); Thomas Hinz, Hamburg (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/447,202

(22) PCT Filed: Oct. 5, 2007
(86) PCT No.: PCT/IB07/54184

§ 371 Date: Apr. 24, 2009

(30) Foreign Application Priority Data
Oct. 26, 2006 (EP) 06122973.8

(51) Int. Cl. G06F 12/00

(52) U.S. Cl. 345/564

(57) ABSTRACT

The invention relates to a address calculation unit (15) for region based image processing tasks, where a processing unit (15) processes the data and exchanges the processed data between a global memory (11) and a local memory (12), wherein the address calculation of region-based algorithms is performed by the address calculation unit in parallel to the date processing of the and the actual processing of data.

### FIELD OF THE INVENTION

The invention relates generally to a address calculation unit for region based image processing tasks.

Image processing tasks are often based on the selection of rectangular regions within a picture. Typically, the applied algorithms for the image processing require a pixel-accurate selection of the region. Therefore the addressing of input and output regions requires complex addressing operations.

### BACKGROUND OF THE INVENTION

Due to the nature of the applied algorithms, it is possible to process several pixels concurrently. For this, SIMD(single instruction multiple data)-type architectures can be efficiently applied. However, one of the major issues arising with this kind of architectural approach is the addressing and selection of input and output operands for a certain operation. Performing the required address calculation requires a significant amount of processing power. As a result, the overall processing performance of the implementation is reduced.

A region-based processing of video data requires a two-dimensional access to input and output data. In current implementations of this processing scheme, the addressing of the input and output regions is performed by calculations carried out on the general-purpose data path that is also used for data processing. As the arithmetic resources can only be used for either data processing or for address calculations, this approach leads to a reduction of available data processing performance. Whenever an address calculation is carried out, the arithmetic units cannot be used for executing data processing. This reduces the overall performance of the implementation too.

### SUMMARY OF THE INVENTION

The aim of this invention is to support an increased efficiency of this processing scheme for programmable embedded hardware implementations and it is an object of the invention to mitigate the drawbacks of the prior art.

The invention relates generally to a address calculation unit for region based image processing tasks according to claim 1. Further inventive advantages are described in the claims 2 to 7.

### BRIEF DESCRIPTION OF THE DRAWINGS

The above and other features and advantages of the invention will be apparent from the following description of an exemplary embodiment of the invention with reference to the accompanying drawings, in which:

FIG. 1 shows a diagram according to the prior art;

FIG. 2 shows a diagram according to the invention;

FIG. 3 shows a frame with an image; and

FIG. 4 shows a table.

### DETAILED DESCRIPTION OF THE DRAWINGS

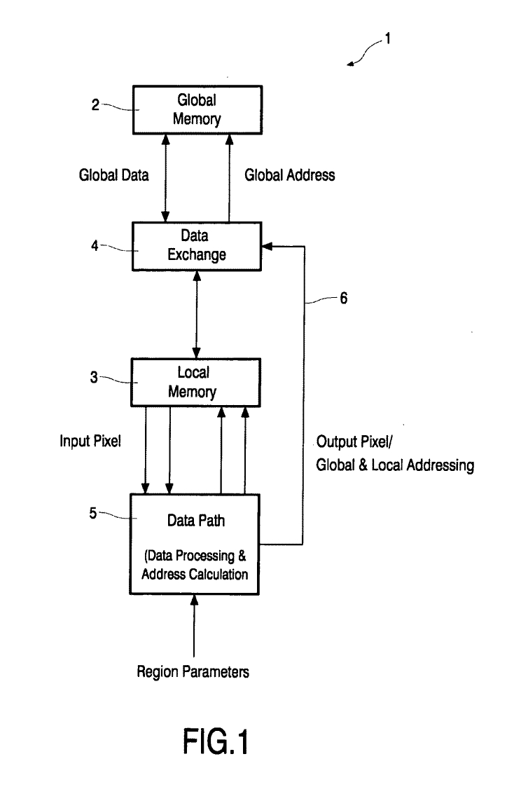

FIG. 1 shows a diagram 1 in which data are exchanged via a data exchange 4 between the global memory 2 and the local memory 3. In the box 5, the data path, the data are processed and the address calculation takes place and regional parameters are input data to the data path. Via the arrow 6 output pixel and global and local address data are transferred to the data exchange.

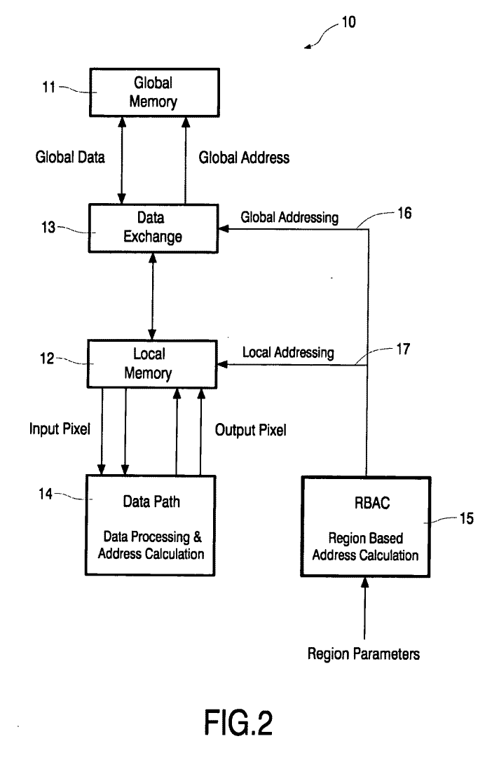

FIG. 2 shows a diagram 10 in which data are exchanged via a data exchange 13 between the global memory 11 and the local memory 12. In the box 14, the data path, the data are processed and the address calculation takes place. In parallel to the data path 14 a region based address calculation 15 is implemented and the regional parameters are input data to the box 15. Via the arrows 16 and 17 output pixel and global and local address data are transferred to the data exchange and to the local memory. The global addressing data are transferred to the data exchange 13 and the local address data are transferred to the local memory 12.

An overview on how a region based addressing scheme can be applied to conventional architectures is depicted in FIG. 2. The region-based addressing scheme runs concurrently to the processing of pixel data, executed on the data path. This does also support the prefetching of data prior to processing, which reduces stalls and increases effective processing performance even further.

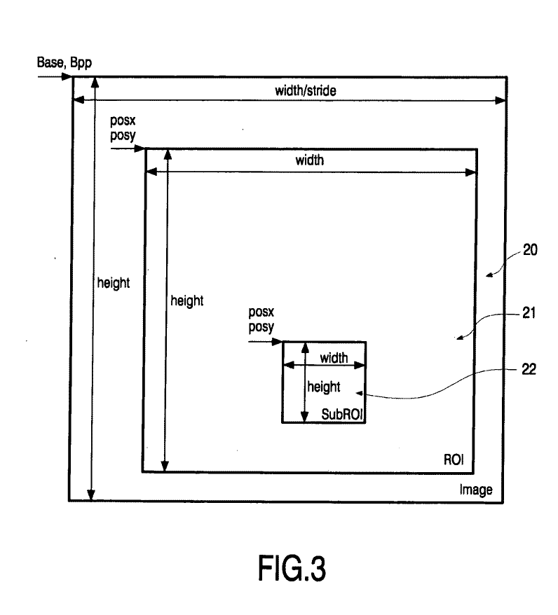

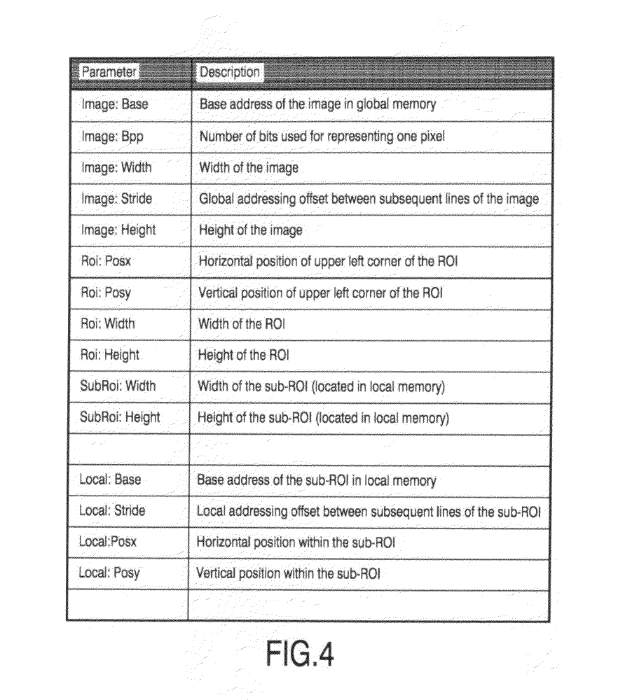

In order to perform an appropriate addressing of input and output data, several parameters have to be known by the addressing unit. As shown in FIG. 3 the parameters describe the location of image data of an image 20 in global memory and location of the image region to be processed 21 (region of interest—ROI). As the size of the ROI 21 is typically too large to be stored entirely in local memory, the processing of the entire region has to be split into several subsequent processing steps of smaller portions, called sub-regions or sub-ROIs 22. The region based address calculation unit keeps track of the memory location of input sub-regions that have to be loaded and the destination address of resulting output sub-ROIs 22. The table of FIG. 4 shows the parameters of an image and their description.

Global addressing for loading and storing sub-ROIs is performed as described by the following formula:

GlobalAddress=Image:Base+((Roi:Posy+SubRoi:Posy)*Image:Stride)+((Roi:Posx+SubRoi:Posx)*Image:Bpp)>>3)

GlobalAddress as well as Image:Base and Image:Stride are assumed to be byte addresses in this example.

The address calculation can be easily extended for non-byte-aligned addressing schemes.

Local addressing for accessing sub-ROI contents is performed according to the following scheme:

LocalAddress=Local:Base+Local:Posy*Local:Stride+(Local:Posx*Image:Bpp)>>3

Local:Stride is assumed to be byte addresses in this example.

In order to achieve high performance processing of region based algorithms, several neighbouring pixels can be combined into one data word that is supplied to the data path. As a consequence the resulting output data calculated by the data path typically contain several neighbouring pixels of the output sub-ROI. Writing of pixel data, that are not part of the sub-ROI, can be avoided by an extension of the previously described implementation of the address generation unit:

In parallel to the generation of a local address for the output sub-ROI a mask is generated. This mask indicates which portion of the result is a valid part of the sub-ROI. Only this part is written to local memory. Portions not belonging to the sub-ROI are discarded.

The masking operation is performed by the following scheme:

If (Local:posy < 0) or (Local:posy > SubRoi:Height−1)
Set Mask to ‘invalid’ for all output pixel;
else if (Local:posx+NPPW < 0) or (Local:posx > SubRoi:Width−1)
Set Mask to ‘invalid’ for all output pixel;
else
Set Mask for all output pixel with position between Local:posx and

SubRoi:Width−1 to valid;

Where NPPW is the number of pixel per output word e.g.

generated by the data path.

The invention described above can be applied for every application that requires region based processing of multi-dimensional data. The described masking operation has advantages for all implementations supporting the concurrent processing of several pixels or generally speaking of data elements.

For example the invention may be applied in an automotive vision controller. Additionally a region-based processing may be applied for video analysis algorithms in the context of video compression and decompression applications.

Improvement are achieved by applying an address calculation unit performing the necessary address calculations required for accessing input and output data. The address calculation is performed in parallel to the data processing.

As an extension to the basic scheme, a mask calculation can be applied. The masking is used if several output pixels are generated concurrently. In case not all generated output pixels are part of the defined output region, setting the associated mask accordingly invalidates these pixel data.

The main advantage of the approach is the split of the relatively complex address calculation of region-based algorithms and the actual processing of data. The parallel implementation of both functions leads to a significant overall performance increase as well as an increased ease of use for region-based image processing algorithms.

The invention allows the concurrent address calculation and data processing of region-based tasks. This is achieved by extending the basic architecture with a dedicated address calculation unit. This address calculation is able to calculate the addresses of input and out put pixels. Moreover, the unit calculates a so-called “write mask” which indicates which part the output data generated by the arithmetic unit contains valid data, i.e. data that is part of the selected output region.

### REFERENCES

1 diagram
2 global memory
3 local memory
4 data exchange
5 box
6 arrow
10 diagram
11 global memory
12 local memory
13 data exchange
14 box
15 address calculation
16 arrow
17 arrow
20 image
21 region to be processed (ROI)
22 sub-ROI

1. An address calculation unit for region based image processing tasks, comprising:
a processing unit;
a global memory; and
a local memory, wherein the processing unit processes data and exchanges the processed data between the global memory and the local memory, and wherein an address calculation of region-based algorithms is performed by the address calculation unit in parallel to the actual processing of data.

2. The address calculation unit according to claim 1, wherein the address calculation unit receives region parameters and generates local and global address data.

3. The address calculation unit according to claim 1, wherein the address calculation unit provides the local memory with local address data.

4. The address calculation unit according to claim 1, further comprising a data exchange unit, wherein the address calculation unit provides the data exchange unit with global address data.

5. The address calculation unit according to claim 1, wherein image data are split into an image region to be processed.

6. The address calculation unit according to claim 1, wherein the region is split into sub-regions.

7. The address calculation unit according to claim 1, wherein the address calculation unit calculates a mask which indicates which part the output data generated by the address calculation unit contains data that is part of a selected output region.
